(19) United States
(12) Patent Application Publication
(10) Pub. No.: US 2014/0201034 A1
(43) Pub. Date: Jul. 17, 2014

(54) Private-Party Vehicle Trade Method and System

(71) Applicant: Richard Heuser, Lake Oswego, OR (US)

(72) Inventor: Richard Heuser, Lake Oswego, OR (US)

(21) Appl. No.: 13/739,096

(22) Filed: Jan. 11, 2013

(51) Int. Cl. G06Q 30/06

(52) U.S. Cl. CPC G06Q 30/0625
USPC 705/26.62

(57) ABSTRACT

Disclosed are methods, apparatus, systems, and non-transitory, tangible computer-readable media associated with private-party vehicle owners wishing to trade their vehicle for another private-party vehicle either permanently or temporarily through an online, electronic bulletin board. In various computer-generated embodiments, a user posts their vehicle's features, details, and pictures along with the type of vehicle they are interested in trading for; including if they wish to give or take money with the trade, how far they are willing to travel outside their zip code, and if they seek a permanent or temporary trade. Vehicle matches are then created, published, and shared between users.

This application claims priority to provisional patent application No.: 61/704,884, filed Sep. 24, 2012, entitled Private-Party, Permanent and Temporary Automobile Exchange.

### BACKGROUND

The majority of people interested in selling their vehicle typically will buy another car. Maybe they want to sell in order to buy something less expensive, maybe an SUV because of their growing family, or maybe something more fuel-efficient.

Owners interested in selling their vehicle typically have two options—trading their car into a dealership or selling it themselves. With a trade-in, the owner will typically receive far less in their trade and pay inflated dealership prices on the new vehicle because of the convenience of selling immediately with minimal hassle. The other option is selling it themselves, and having to deal with tire-kickers, lowball offers, and no-shows on appointments in hopes they will eventually get a fair price for their car. If they succeed in selling their vehicle, they then have to go through the hassle of searching for another to buy. What about having the convenience of a trade-in, selling your vehicle for a fair price, buying another for a price that is far less than retail, and doing so all in one step?

### BRIEF DESCRIPTION OF THE DRAWINGS

Embodiments of the present invention will be readily understood by the following detailed description in conjunction with the accompanying drawings of each web page and flow chart. Each Web page drawing is meant to just show functionality and features, no design element. Embodiments of the invention are illustrated by way of example and not by way of limitation in the figures of the accompanying drawings.

FIG. 1: Home Page of the site.

FIG. 2: Listing Vehicle page.

FIG. 3: Find Your Trade page.

FIG. 4: Search for Vehicle/Vehicle Search Results page.

FIG. 5: Vehicle Details page.

FIG. 6: Member Profile page.

FIG. 7: Member Contact Preference page.

FIG. 8: Creating Account/Payment page.

FIG. 9: Membership Account page.

FIG. 10: Edit Membership Profile page.

FIG. 11: Edit Listings page.

FIG. 12: Edit Trade Searches page.

FIG. 13: Contact Us page.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present invention; however, the order of description should not be construed to imply that these operations are order dependent.

Vehicles that may be traded may include, automobiles, motorcycles, Recreational Vehicles (RVs), boats, and miscellaneous (any trade item that is not a vehicle). Any miscellaneous item is either an item the owner wants to trade for a vehicle or they want to trade their vehicle for a miscellaneous item.

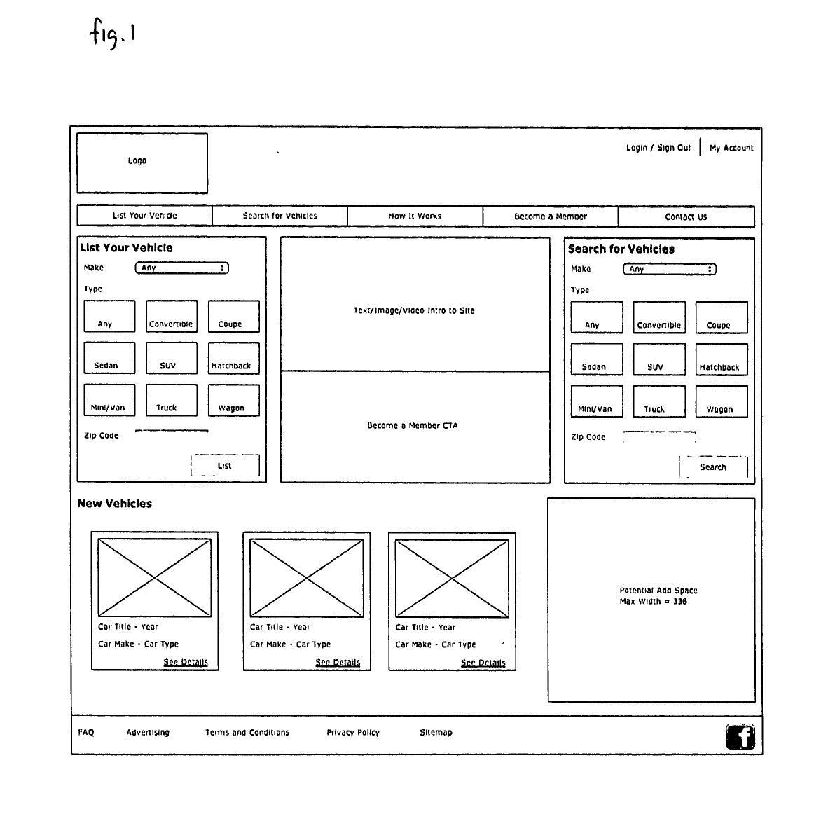

Home page of Web site introduces the user to listing their vehicle, searching for a vehicle to trade for, how to become a member, and learning about the trading process (see FIG. 1). In addition, advertising banners may be included.

“How It Works” videographic or infographic will appear on Home Page. User clicks this to get educated on the trading process, benefits of a vehicle trade, and the benefits of becoming a member.

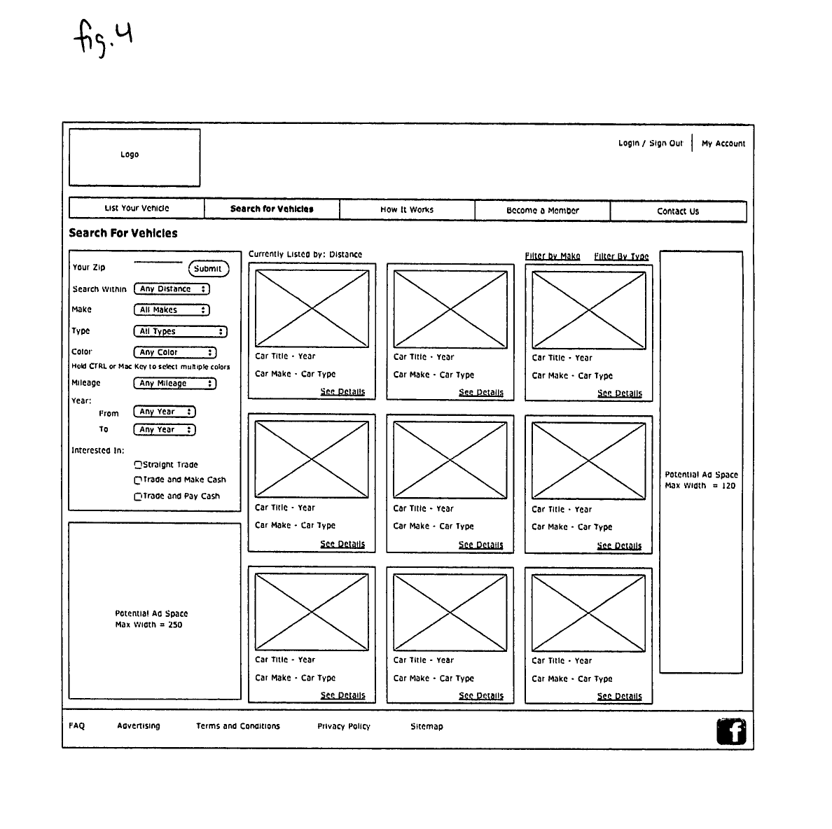

Vehicle Search: Users will search for vehicles in the system via a search on the search page (see FIG. 4). Searches may include the following: Temporary or Permanent Trade?, Make, Type, Year, Color, Mileage, Zip Code distance (how many miles outside of user's zip code each car in search results is located), and if the user is interested in trades with: 1. No money exchanged, 2. Plus money, 3. Pay money. As a default, all fields may show “any” to maximize the vehicle search population. A user can then create a more specific search criteria on any of the fields they wish. For example, a user can search for a permanent trade for any 2005 Ford Explorers, blue, under 50,000 miles, within 10 miles of their zip code, be as general as any car with or without cash exchanged. If search user is a member, they will be able to search for up to three different search criteria and see the name and contact information of their search result. If not a member or not logged in, the user will see a prompt to register or login. Other than sharing vehicle contact information between two users, user-to-user communication is independent of the site.

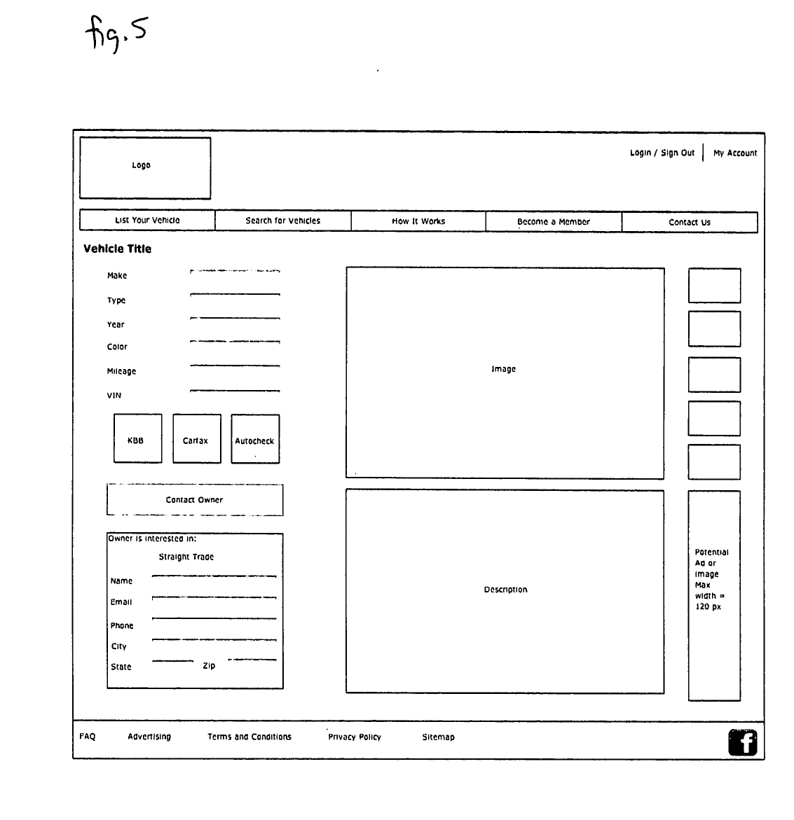

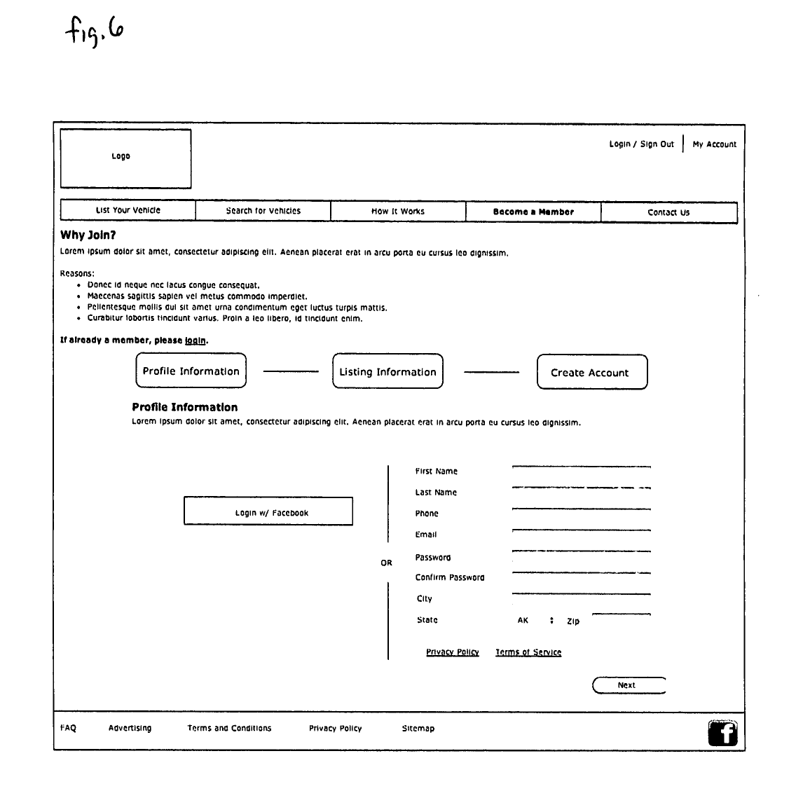

A list of vehicles appear that match the user's search criteria (see FIG. 4) and, as a default, may be listed in order of when the vehicle first appeared on the site (oldest vehicle first). The user may also categorize the search results based on vehicle make, or on proximity from user's zip code. A user can then click on a specific vehicle for more detailed information (see FIG. 5) that includes car information, any images that were uploaded from member, along with owner contact information (if user is a member) or a “Contact Owner” icon if user is either not logged in or for a prospective member. Once user clicks this icon, Profile Information page will appear (FIG. 6) where member can log in or prospective member can view membership details, including member benefits and costs.

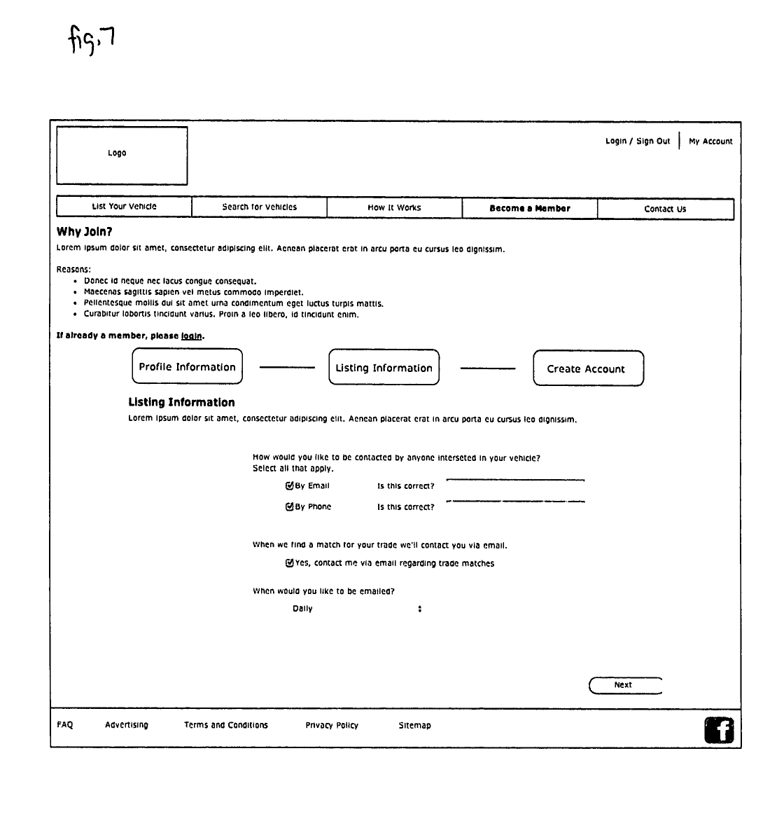

For new members, Member Contact Preference page appears (see FIG. 7) which asks member how they wish to be contacted by other users who are interested in their vehicle for trade. Options include: by email, phone, or text message. On this page, member has option to select if, and how frequently, they wish to be notified via email on trade matches.

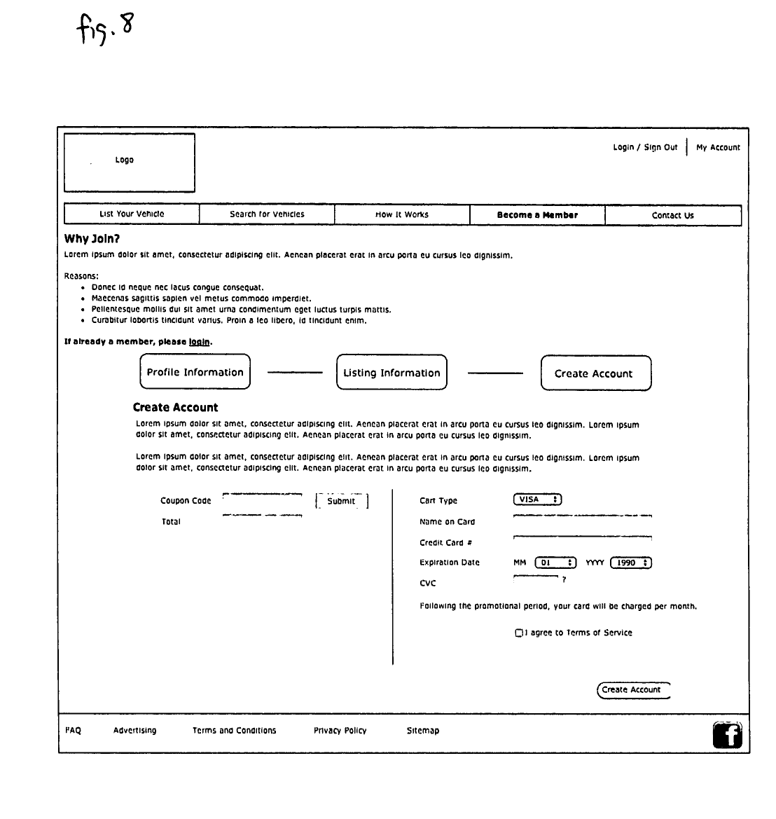

Once Member Contact Preference page is complete, new member then submits credit card information (see FIG. 8) and initial membership fee is charged. User can enter any Coupon Code and system will apply it immediately and notify user of amount due. Credit card is charged through Authorized.net and credit card information is stored securely through Authorized.net.

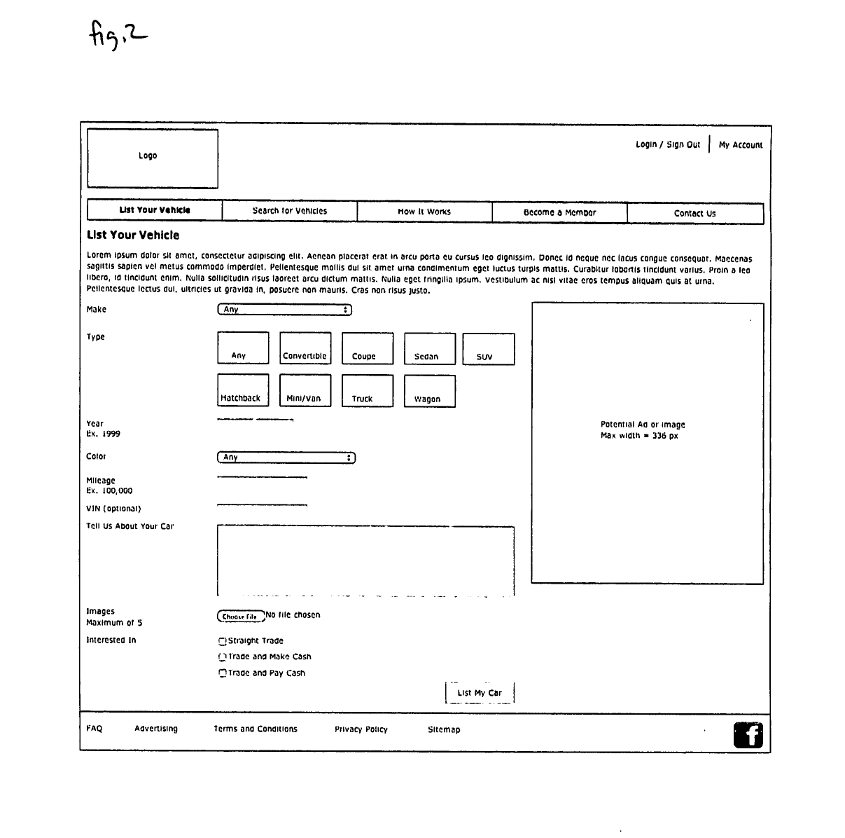

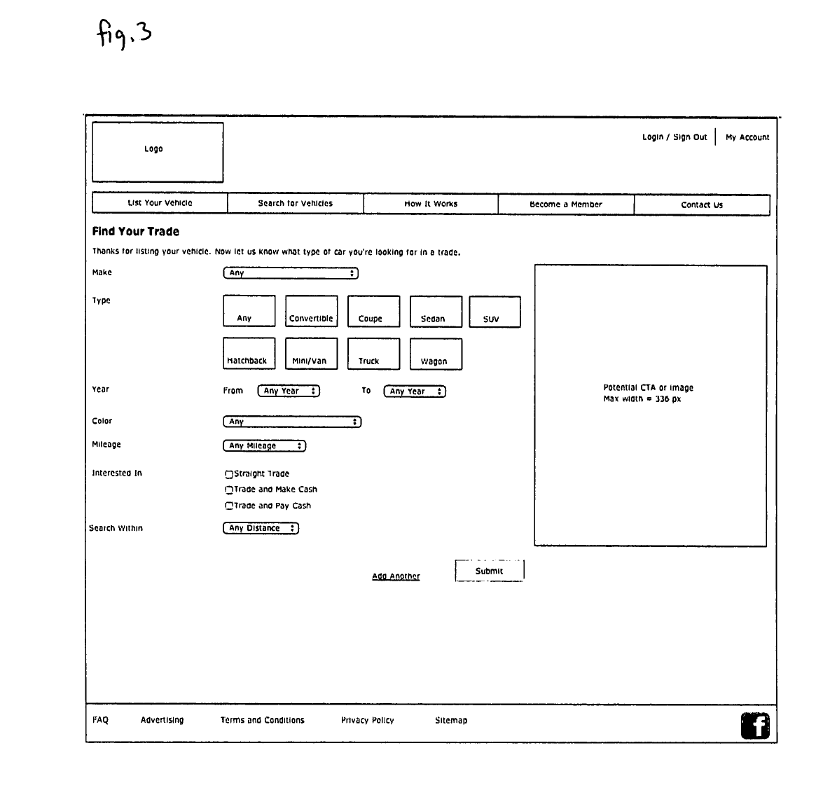

Vehicle Listing: Listing a vehicle will require the user to have an account and be logged into the system. Once logged in, the first step will be to submit the vehicle to be listed and, secondly, to submit what vehicle the user is searching for (see FIG. 2). Specialized fields, search, imagery, advertisements, and Kelly Blue Book, Carfax and/or Autocheck iconography may be included as well (see FIG. 2). A user has the following features available when listing their vehicle: Make, Type, Year, Color, Mileage, VIN, “Tell Us About Your Vehicle,” and whether they are interested in a straight trade, trade and make cash, or trade and pay cash. In addition, the user has the ability to upload to their listing multiple pictures. Once the user selects the “List My Vehicle” icon they are prompted to select the automobile(s) they are interested in trading for (see FIG. 3). The same criteria applies as when they listed their vehicle, with the ability to add multiple types of searches independent of one another but all matched up to their listing vehicle.

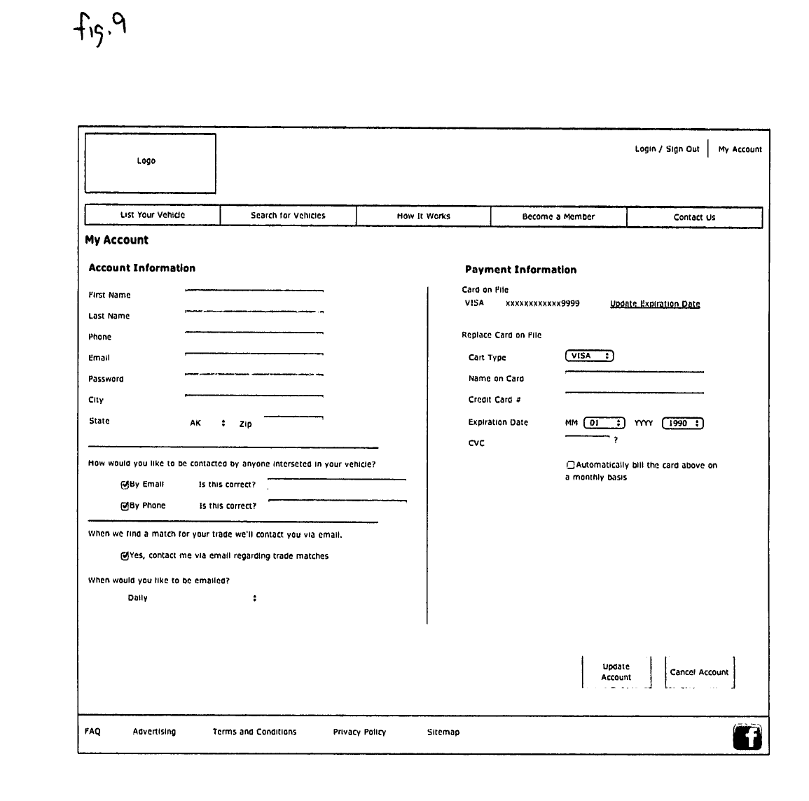

Account Management: Users will need to create an account in order to (1) list their vehicle on the site, (2) see contact information for other users' listings, and (3) receive email alerts for matches. Users will have ability to (1) update their profile and credit card information, (2) edit their vehicle listing, and (3) edit their trade searches on the Member Account Page (see FIG. 9).

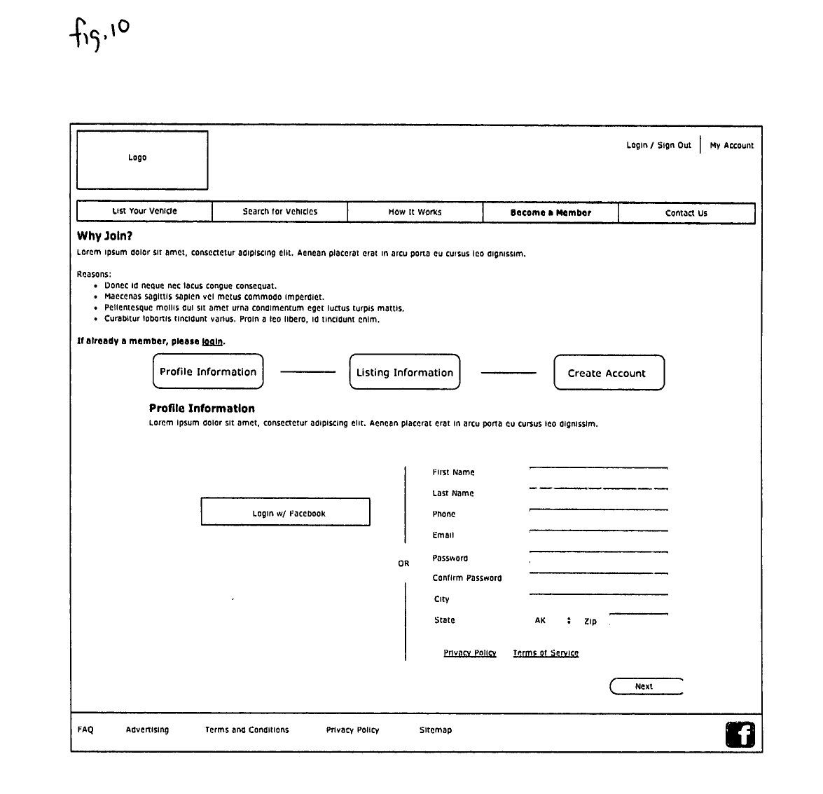

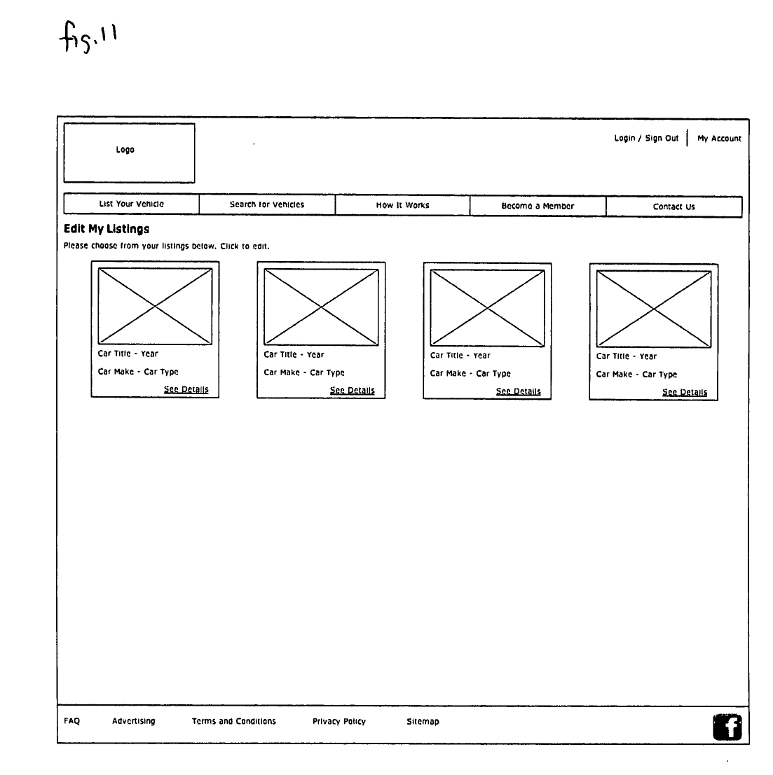

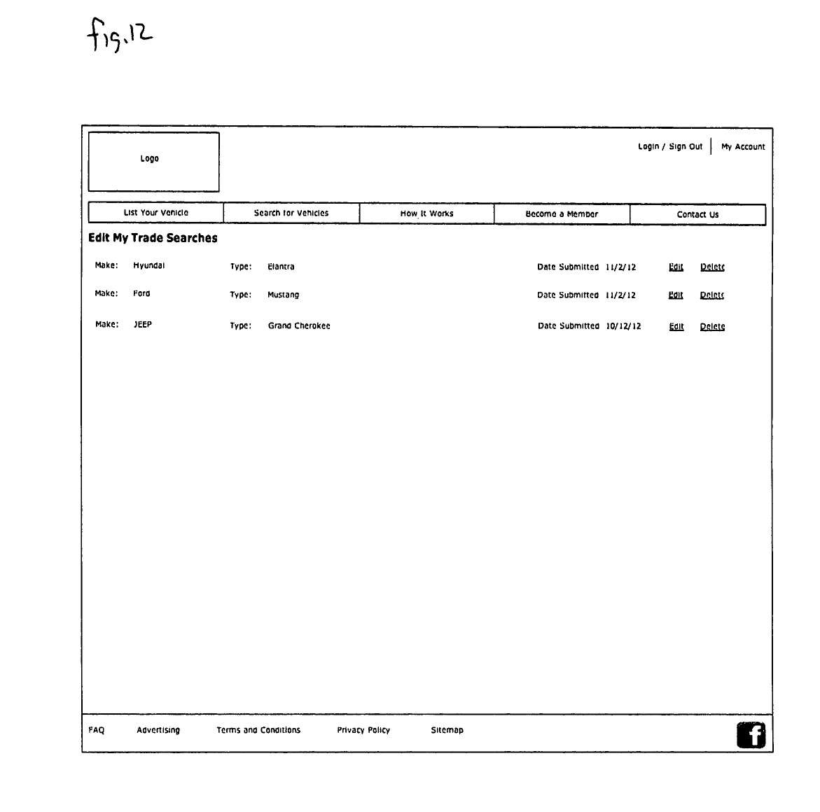

Membership Account Page: Member can update phone number, email address, reset their password, revise how they wish to be contacted by other members, and change if, and how frequently, they wish to be notified via email on trade matches on the Membership Profile Page (see FIG. 10). Members may also change the credit card on file. In addition, members can revise their vehicle listing (FIG. 11) and edit or delete their trade searches (FIG. 12).

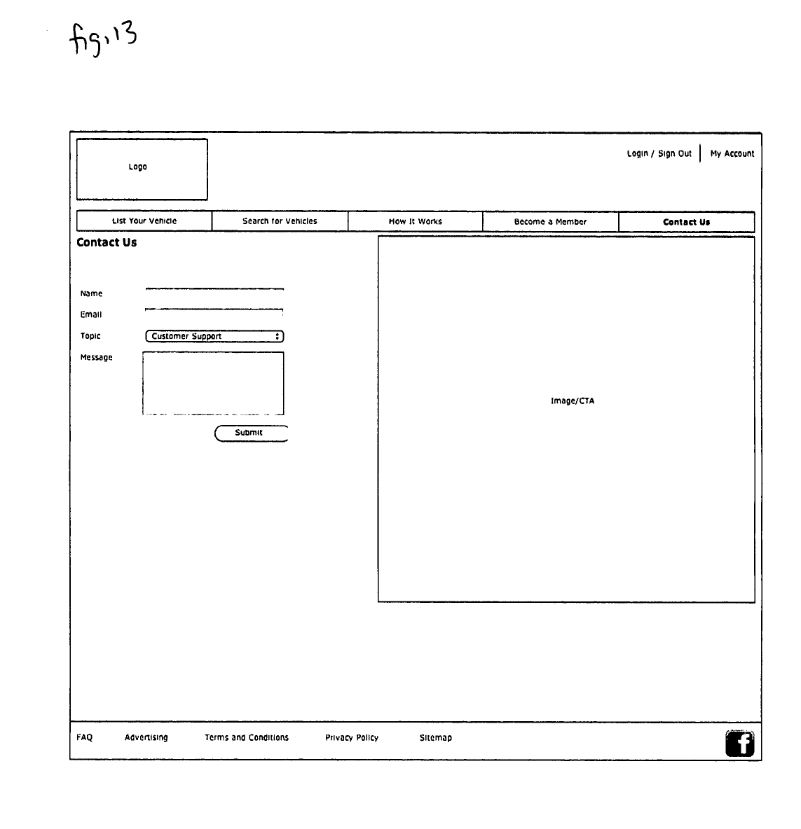

Contact Us Page (see FIG. 13): Allows users (both members and prospective customers) to be able to contact company via email for questions or concerns relating to, but not limited to: customer service, billing, advertising, feedback, and technical support. The administrator can then look up a member's listing and profile from the email address given on the inquiry for member-related inquiries. A drop down menu will categorize each inquiry topic and the system will then send an email to the administrator's email address. Administrator may have separate email accounts for each of the drop down topics so the appropriate staff can manage appropriately (e.g. billing@vehitrade.com, advertising@vehitrade.com, etc.). This site may also add a phone number as well for the above-mentioned topics.

Payment Solution: Users will be charged an upfront membership fee beginning the date they registered. This will give them full membership privileges for a set time period. After this time period expires, users are automatically charged a monthly fee. Their account will be charged until the account is cancelled by the user or a site administrator (see Members Manager, above). Solution may be integrated with Authorize.net, which makes accepting credit card payments safe, easy, and affordable.

Members' Manager—Manage users' profiles: Via module function will be able to access, edit, delete, or export member information via CSV format. Also may have capability to “restore” deleted account, if appropriate, to result in limited or zero impact related to the billing cycle.

Administrator Manager: System may also allow ability to manage advertising, view and reset Web site counter; and revise images, text, links, membership costs and initial membership timeframes.

System Emails: With subscription services, it's paramount to keep the lines of communication between member and company open. System allows company to manage emails that help to keep users in the sales funnel. Users may receive emails when: 1. An account is created; 2. When an account is deleted; 3. When a match is made based on the “Trade Search” form(s) submission; 4. Forgot password; 5. Credit card declined; and 6. Credit card charged.

Coupon Module: With this module, administrator has the ability to create coupons or promotional codes for either a discount on the upfront and/or monthly fee and set the duration the coupon is available. The coupon may either be percentage- or price-based.

IP Lookup: Every machine that is on a local network, or the Internet as a unique Internet Protocol (IP) address. IP-Lookup helps you to find information about the current IP address or any other IP address. Users' IP addresses may be gathered in order to display the nearest vehicle on the 1. Home Page, 2. Search List Page, and 3. IP-based advertisements. Certain advertisements may be displayed to users based on their IP address and/or zip code they entered when beginning the search or listing process.

Advertising Module: Allows administrator to add an advertisement to designed areas of the Home, List, Search, and Vehicle Listing pages. Module will allow administrator to determine page, upload advertisement, insert link for ad, and enter specific zip code along with how miles outside zip code advertisement will appear on a user's computer based on their IP address and/or zip code. Advertisements may be horizontal, vertical, or block with a maximum width and/or height depending on the designated location on the site.

Smart Phone Optimization: Site will be built tablet-friendly by default and, with new template design, allow users to search and log-in to their accounts via any compatible mobile device. Specifically, allows the ability to search cars (where members can log in and see which cars match) and manual search where prospective customers can search cars and enter their car information to see any relevant matches. Allows for greater conversions and user-to-user conversations, as site reaches audience wherever they are.

1. A computer-implemented method for matching vehicle trade interests, the method comprising:
inputting, with a computer device, a vehicle owner's car for trade;
searching, with a computer device, matches for a vehicle trade;
matching, by a computer device, together two automobiles based on vehicle owners' trade search criteria;
receiving, by a computer device, one or more matches to a user;
storing, by a computer device, one or more vehicle matches; and
sharing, by a computer device, vehicle owners' contact information for each match.

2. The method of claim 1, wherein inputting specific details of an automobile owner's vehicle for trade including: miscellaneous details, images, mileage, color, year, make, model, clear or salvaged title, approximate value, zip code proximity range, and with or without cash given or received.

3. The method of claim 2, wherein inputting miscellaneous details of the vehicle to further enhance the listing. This may include, but not limited to, details such as options (e.g. power windows, heated seats, sunroof, etc.), interior color, wheel size, and overall condition of the vehicle.

4. The method of claim 1, wherein matching, specific details of a vehicle owner's car for trade including: mileage, color, year, make, model, zip code proximity range, with or without cash given or received.

5. The method of claim 1, further comprising inputting, which vehicle(s) the owner is interested in trading for.

6. The method of claim 3, to select what specific trade search criteria(s) user wishes, based on following options: year range, make, model, type, mileage, color, zip code proximity range.

7. The method of claim 1, further comprising; inputting, whether user seeks permanent or temporary vehicle trade;
matching, those permanent or temporary trades, with any other relevant trade details.

8. The method of claim 1, further comprising:
receiving, by a computer device, all relevant matches to a user through either a manual search, where the user either logs in and computer recognizes user's listing vehicle or user inputs their car to trade and search results appear, or a computer-generated match.

9. The method of claim 6, further comprising:
storing, by a computer device, such computer-generated matches;
receiving, wherein receiving computer-generated email to user notifying them and supplying details of vehicles that match their criteria, if they prefer such notification.

10. (canceled)

11. The method of claim 1, further comprising sharing, by a computer device, the vehicle owners' contact information, including phone number, text message, and/or email for each match. Preferences are set for each user on how they wish to be contacted.

12-17. (canceled)

18. Method of claim 7, further comprising notifying the user regarding computer-generated matches on a frequency that the user selects.
